(19) United States
(12) Patent Application Publication
(10) Pub. No.: US 2011/0072817 A1
(43) Pub. Date: Mar. 31, 2011

(54) SOLAR-BASED POWER GENERATOR

(76) Inventor: John Lee, Germantown, MD (US)

(21) Appl. No.: 12/452,273

(22) PCT Filed: Mar. 25, 2009
(86) PCT No.: PCT/US2009/001866

§ 371 Date: Dec. 23, 2009

(51) Int. Cl. F03G 6/06

(52) U.S. Cl. 60/641.15

(57) ABSTRACT

The solar-based power generator (10) is a system for producing usable electricity from water, which is heated through concentration of ambient, environmental light. The generator (10) includes a reservoir (12) having an open upper end. The reservoir (12) receives a volume of water (14) therein. A convex lens (16) is mounted on an upper edge of the reservoir (12). The convex lens (16) covers the open upper end. A steam output port (11) is in fluid communication with a steam-based electrical generator (18). The convex lens (16) concentrates ambient light on the water (14) stored within the reservoir (16), thus heating the water (14) and converting the liquid water to steam. Additionally, a methane-burning electrical generator (24) is in communication with the reservoir (12). Pollutants in the water (14) produce methane during heating and decomposition, which is burned by the methane-burning electrical generator (24).

### TECHNICAL FIELD

The present invention relates to power generation, and more particularly to a solar-based power generator that uses a magnifying glass to concentrate ambient light on a volume of water or sewage to produce steam and/or methane gas, which then powers a steam generator and/or a methane burner to produce usable electricity.

### BACKGROUND ART

The availability of unlimited solar energy, in the form of solar radiation and heat, is an attractive source of energy for a wide variety of reasons, and for many diverse purposes. Many applications for harnessing or using solar radiation to generate electricity, or a useful mechanical output, are known. For example, silicon solar cells, which respond to light from the sun, are used to generate electricity, which then may be used directly or stored by charging a battery. Typically, solar cells generate only small amounts of electricity, so that solar cell systems generally are used only to operate electronic devices requiring relatively low power levels, such as portable calculators and the like.

Solar cell arrays many square feet in size have been used to power direct current motors to operate larger equipment, such as pool pumps and the like. Typically, however, solar cell arrays need to be extremely large in order to produce any substantial quantity of electricity. As a result, such solar cell arrays have not been found to be a practical source for utilizing energy from the sun, except in a few very specialized cases. Additionally, solar cells must be very carefully manufactured, using complex and costly processes, some of which are harmful, due to byproducts, to the environment.

It would be desirable to provide an electrical generator which relies on solar energy, but which is also efficient in energy production, and which his further environmentally friendly. Thus, a solar-based power generator solving the aforementioned problems is desired.

### DISCLOSURE OF INVENTION

The solar-based power generator is a system for producing usable electricity from water, which is heated through concentration of ambient, environmental light. The solar-based power generator includes a reservoir having a base, at least one sidewall and an open upper end. The reservoir is dimensioned and configured for receiving a volume of water therein. A water input port is formed through the at least one sidewall, and water may be input using any suitable type of water pump or the like. The water may be from any source, including seawater, polluted or contaminated water, sewage or the like.

A convex lens is mounted on an upper edge of the at least one sidewall of the reservoir. The convex lens covers the open upper end of the reservoir. The convex lens includes upper and lower surfaces, which are preferably both convex, i.e., the lens is a double convex or converging lens, and preferably each surface has a constant radius of curvature.

Further, a steam output port is formed through the at least one sidewall, preferably above a fixed water line within the reservoir. A steam-based electrical generator is in communication with the interior of the reservoir, through the steam output port. The convex lens concentrates ambient light on the volume of water stored within the reservoir, thus heating the water and converting the water to steam. The steam generator generates usable electricity, which may then be drawn off to be used by external devices.

Additionally, a methane output port is preferably also formed through the at least one sidewall, also preferably above the fixed water line within the reservoir. A methane-burning electrical generator is in communication with the interior of the reservoir, through the methane output port. Pollutants in the water or sewage produce methane gas during heating and decomposition thereof, which may then be burned by the methane-burning electrical generator for producing further usable electricity.

These and other features of the present invention will become readily apparent upon further review of the following specification and drawings.

### BRIEF DESCRIPTION OF THE DRAWINGS

FIG. 1 is a diagrammatic view of a solar-based power generator according to the present invention.

FIG. 2 is a side view of a lens for a solar-based power generator according to the present invention.

Similar reference characters denote corresponding features consistently throughout the attached drawings.

### BEST MODES FOR CARRYING OUT THE INVENTION

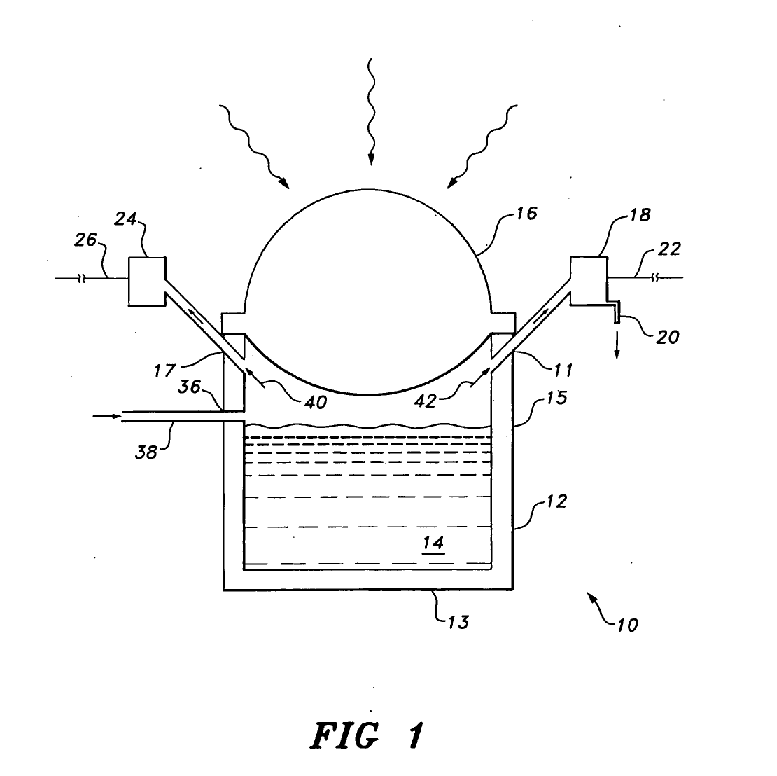

As shown in FIG. 1, the solar-based power generator 10 provides a system for producing usable electricity from water 14, which is heated through concentration of ambient, environmental light. The solar-based power generator 10 includes a reservoir 12 having a base 13, at least one sidewall 15 and an open upper end. Reservoir 12 may be formed from any suitable non-corrosive and watertight material. The reservoir 12 is dimensioned and configured for receiving a volume of water 14 therein. A water input port 36 is formed through the at least one sidewall 15, and water 14 may be input using any suitable type of water pump or the like through an input pipe 38. The water 14 may be from any source, including seawater, polluted or contaminated water, sewage or the like. It should be understood that multiple generators 10 may be used in a large-scale power plant.

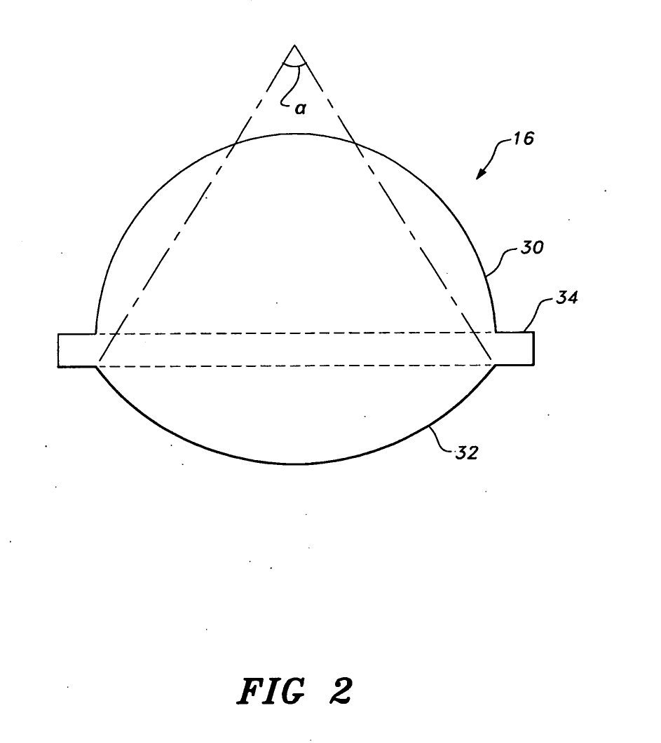

A double convex lens 16 is mounted on an upper edge of the at least one sidewall 15 of the reservoir 12. The lens 16 covers the open upper end of the reservoir 12. As best shown in FIG. 2, the lens 16 includes upper and lower surfaces 30, 32, respectively, which are both convex. Preferably, each surface 39, 32 has a constant radius of curvature. Preferably, the upper surface 30 of the convex lens spans an arc of approximately 180° and the lower surface 32 spans an angle α in a range between approximately 30° and 45°. The relatively wide arc of upper surface 30 allows for reception of ambient light over a wide range, thus making generator 10 usable at any time during the day, with the sun in any position. As shown, the upper and lower portions of lens 16 may be separated by a substantially rectangular (in side cross-section) central portion 34, with the outer rim of central portion 34 providing a surface which rests on the upper edge of the at least one sidewall 15. The rim of central portion 34 is preferably secured in a fluid-tight fashion to the upper edge, so that steam or methane produced in the reservoir 12 does not escape around the lens 16. Lens 16 may be formed from any suitable type of material, such as transparent and colorless glass, and is dimensioned and configured to cover the upper edge of reservoir 12. It should be understood that any suitable type of lens, or a plurality of lenses, may be utilized, depending upon the particular power production needs of the user. The lens 16 or other external lenses may further be used to pre-heat the water 14 before input into reservoir 12. Alternatively, any other suitable type of water heater may be used for this purpose.

Further, a steam output port 11 is formed through the at least one sidewall 15, preferably above a set water line within the reservoir 12. A steam-based electrical generator 18 is in fluid communication with the interior of the reservoir 12 via the steam output port 11. The lens 16 concentrates ambient light on the volume of water 14 stored within the reservoir 12, thus heating the liquid water 14 and converting the liquid water 14 to steam (indicated by arrows 42). The steam generator 18 generates usable electricity, which may then be drawn off by any suitable line 22 to be used by external devices. Additionally, distilled water, produced by the used, cooled steam in generator 18, may be drawn off via a tap 20, for storage as purified, potable water. Steam generator 18 may be any suitable type of steam-based electrical generator, such as a steam turbine generator or the like. Such steam-based generators are well known in the art. Examples of steam-based turbine generators are shown in U.S. Pat. No. 3,567,952, issued to Doland; U.S. Pat. No. 3,628,332, issued to Kelmar; and U.S. Pat. No. 3,871,180, issued to Swanson, each of which is herein incorporated by reference in its entirety.

Additionally, a methane output port 17 is preferably also formed through the at least one sidewall 15, also preferably above the set water line within the reservoir 12. A methane-burning electrical generator 24 is in fluid communication with the interior of the reservoir 12, via the methane output port 17, such that pollutants in the water 14 produce methane gas during heating and decomposition thereof (indicated by arrows 40), which may then be burned by the methane-burning electrical generator 24 for producing further usable electricity, which is drawn off by any suitable line 26 for storage or usage by external devices. Methane generator 24 may be any suitable type of methane-based electrical generator. Such methane-burning generators are well known in the art. Examples of methane-based generators are shown in U.S. Pat. No. 4,759,300, issued to Hansen et al.; U.S. Pat. No. 4,942,734, issued to Markbreiter et al.; U.S. Pat. No. 6,523,348, issued to Acharya et al.; and U.S. Pat. No. 6,601,543, issued to Rautenbach et al.

Following evaporation of water 14 within reservoir 12, remaining residue, such as salt from seawater, organic matter from sewage, and/or chemicals from contaminated water, may be collected and used for other purposes. In operation, the user may switch between power generation from steam and power generation from methane, depending upon the particular type of liquid contained within reservoir 12 (for example, seawater would make use of steam-based electrical generator 18, without producing methane, and raw sewage would make use of methane-burning generator 24). The user may either selectively activate the appropriate generator, or an automatic separator, for separating methane gas from steam, may be utilized.

It is to be understood that the present invention is not limited to the embodiments described above, but encompasses any and all embodiments within the scope of the following claims.

1. A solar-based power generator, comprising:
a reservoir having a base, at least one sidewall and an open upper end, the reservoir being adapted for receiving a volume of water;
a convex lens mounted on an upper edge of the at least one sidewall of the reservoir, the convex lens covering the open upper end thereof; and
means for generating electricity from steam;
whereby the lens concentrates ambient light on the volume of water stored within the reservoir, heating the water and converting the water to steam, the means for generating electricity from the steam receiving the steam and generating usable electricity.

2. The solar-based power generator as recited in claim 1, wherein said convex lens has opposed upper and lower surfaces, the upper and lower surfaces each being convex.

3. The solar-based power generator as recited in claim 2, wherein each of the upper and lower surfaces has a constant radius of curvature.

4. The solar-based power generator as recited in claim 3, wherein the upper surface of said convex lens spans an arc of approximately 180° and the lower surface of said convex lens spans an angle in a range between approximately 30° and 45°.

5. The solar-based power generator as recited in claim 1, further comprising means for selectively and controllably inputting the water into said reservoir.

6. The solar-based power generator as recited in claim 5, wherein an input port is formed through the at least one sidewall.

7. The solar-based power generator as recited in claim 6, wherein a steam output port is formed through the at least one sidewall, said means for generating electricity from the steam being in communication with the steam output port.

8. The solar-based power generator as recited in claim 7, further comprising means for extracting distilled water from said means for generating electricity from the steam.

9. The solar-based power generator as recited in claim 8, further comprising means for generating electricity from methane, pollutants in the water within the reservoir producing methane during heating and decomposition thereof.

10. The solar-based power generator as recited in claim 9, wherein a methane outlet port is formed through the at least on sidewall, said means for generating electricity from the methane being in communication with the methane outlet port.

11. A solar-based power generator, comprising:
a reservoir having a base, at least one sidewall and an open upper end, the reservoir being adapted for receiving a volume of water;
a convex lens mounted on an upper edge of the at least one sidewall of the reservoir, the convex lens covering the open upper end thereof; and
means for generating electricity from methane;
whereby the lens concentrates ambient light on the volume of water stored within the reservoir, heating the water, pollutants in the water producing methane during heating and decomposition thereof, the means for generating electricity from the methane receiving the methane and generating usable electricity.

12. The solar-based power generator as recited in claim 11, wherein said convex lens has opposed upper and lower surfaces, the upper and lower surfaces each being convex.

13. The solar-based power generator as recited in claim 12, wherein each of the upper and lower surfaces has a constant radius of curvature.

14. The solar-based power generator as recited in claim 13, wherein the upper surface of said convex lens spans an arc of approximately 180° and the lower surface of said convex lens spans an angle in a range between approximately 30° and 45°.

15. The solar-based power generator as recited in claim 11, further comprising means for selectively and controllably inputting the water into said reservoir.

16. The solar-based power generator as recited in claim 15, wherein an input port is formed through the at least one sidewall.

17. The solar-based power generator as recited in claim 16, wherein a methane output port is formed through the at least one sidewall, said means for generating electricity from the methane being in communication with the methane output port.

18. The solar-based power generator as recited in claim 17, further comprising means for generating electricity from steam, said convex lens concentrating the ambient light on the volume of water stored within said reservoir, heating the water and converting the water to steam, said means for generating electricity from the steam receiving the steam and generating usable electricity.

19. The solar-based power generator as recited in claim 18, further comprising means for extracting distilled water from said means for generating electricity from the steam.

20. The solar-based power generator as recited in claim 19, wherein a steam outlet port is formed through the at least on sidewall, said means for generating electricity from the steam being in communication with the steam outlet port.
